(19) United States
(12) Patent Application Publication
(10) Pub. No.: US 2004/0111798 A1
(43) Pub. Date: Jun. 17, 2004

(54) Stretcher

(76) Inventors: Shigeyuki Matunaga, Gifu (JP); Hiromi Matuki, Gifu (JP)

Correspondence Address: Cary Tope McKay, 23852 Pacific Coast Highway #311, Malibu, CA, 90265, US

(21) Appl. No.: 10/250,379

(22) PCT Filed: Dec. 25, 2001
(86) PCT No.: PCT/JP01/11410

(30) Foreign Application Priority Data
Dec. 26, 2000 (JP) 2000-394830
Jun. 11, 2001 (JP) 2001-175106

(51) Int. Cl. A61G 7/10

(52) U.S. Cl. 5/86.1; 5/625

(57) ABSTRACT

In a stretcher (100) comprising an upper frame (11) for placing a litter on an upper portion thereof having casters (41) and (42) in the front and rear portions, and a slide mechanism for changing up/down the position of the upper frame (11), the stretcher (100) is provided with a non-step stopper mechanism for stopping the sliding in the slide mechanism in a non-step manner. As a result, the height of the stretcher (100) can be changed up/down smoothly without rendering pain or uneasiness to a patient.

### FIELD OF THE INVENTION

The present invention relates to a stretcher used for emergency medical service to carry a sick person, an injured person, a patient, an aged person or the like.

### DESCRIPTION OF THE RELATED ART

A stretcher is for carrying a sick person or an injured person with a litter placed thereon. Particularly, when a patient complains of an ache, even a small vibration amplifies the ache. In an up/down slide system of a conventional stretcher, a lock mechanism of oil spring is adopted. When locking, a pin is inserted into a hole and thereby the up/down slide system is locked at a given position. In the above system, stop positions are restricted to several steps. Additionally, while sliding up/down the stretcher, sometimes it takes a long time to fix the stretcher since the pin is hardly inserted into the hole; the pin is hardly pulled out; or it may stop halfway to cause a malfunction, resulting in a sudden lowering of the stretcher. As a result, sometimes pain and uneasiness may be rendered to the patient while sliding up/down the stretcher.

A sick person or injured person is apt to feel strong uneasiness and sensation of fear by just being laid down on a litter placed on a stretcher. In order to relieve such uneasiness and sensation of fear as described above as far as possible, it is desired to provide such stretcher that slides up/down smoothly and is capable of being fixed at any position.

An object of the invention is to provide a stretcher equipped with a non-step stopper mechanism capable of changing the height of a stretcher up/down smoothly in a non-step manner without rendering pain or uneasiness to a patient.

### SUMMERY OF THE INVENTION

As a result of intensive studies in order to solve the above-mentioned problems, the invention adopts a non-step stopper mechanism, which is capable of fixing a stretcher at a desired point of height, and capable of stopping the slide mechanism, which moves the stretcher up/down smoothly in a non-step manner. As a result, a stretcher of little sliding resistance and capable of being fixed at a desired position has been created successfully and the above-described problems has been solved.

A first aspect of the invention is a stretcher comprising an upper frame for placing a litter on an upper portion thereof having casters in the front portion and rear portion, and a slide mechanism for changing up/down the position of the upper frame, characterized in that a non-step stopper mechanism for stopping the sliding in the slide mechanism in a non-step manner is provided. Owing to a slide system for changing up/down the height of the stretcher and an arrangement of the non-step stop, it is possible to slide up/down the stretcher and to fix the same at a desired position, and little superfluous vibration is rendered. As a result, a patient can be free from pain or uneasiness.

A second aspect of the invention is a stretcher characterized in that the sliding of the slide mechanism is made by the expansion and contraction of a constant force spring. By using a constant force spring in the slide mechanism for changing up/down the height of the stretcher, the up/down movement is performed smoothly. As a result, an effect that a patient can be free from uneasiness or pain during the up/down movement.

A third aspect of the invention is a stretcher characterized in that the non-step stopper mechanism comprises a mechanical lock structure. By adopting the mechanical lock structure for stopping the movement while the height of the stretcher is changed up/down, unlike a mechanism in which a pin is inserted into a previously formed hole, stop position and fixing position are not limited to specific positions. Accordingly, there is no amplification of pain due to the vibration generated by insertion of the pin into the hole, or danger of sudden lowering of the stretcher due to such malfunction as a fail of the pin being inserted into the hole etc, as the case of the conventional mechanism.

A fourth aspect of the invention is a stretcher characterized in that the front caster is an un-turnable fixed caster. By adopting the un-turnable fixed caster for the front casters, it is possible to prevent the stretcher from staggering resulting in a stable conveyance.

A fifth aspect of the invention is a stretcher characterized in that a stopper is disposed to the right and left front fixed casters respectively, and the right and left stoppers are interlocked with each other. The front casters are un-turnable fixed casters, and the right and left casters are provided with stoppers, and these right and left stoppers are interlocked. Accordingly, by stepping on either one stopper of these right and left front fixed casters, the right and left casters can be fixed at the same time. As a result, the stretcher can be stopped stably.

A sixth aspect of the invention is a stretcher characterized in that the litter can be fixed by a key-like hook of the upper frame. When the litter is placed on the stretcher, the litter can be fixed and unfixed easily by means of the key-like hooks provided to the upper frame. Further, since the fixing means are disposed at the outer sides of the upper frame, it is easily checked whether the litter is fixed. As a result, the litter with a patient thereon can be fixed to the stretcher and be conveyed with security.

A seventh aspect of the invention is a stretcher characterized in that front leg and rear leg slide mechanisms are provided in a lower portion of the upper frame. By disposing the front leg and rear leg non-step stopper mechanisms in a lower portion of the upper frame, it is possible to prevent the stopper mechanism from being exposed to the external. As a result, such a danger as a foreign matter is caught by the stopper mechanism during operation is eliminated and a satisfactory appearance is realized as well.

### BRIEF DESCRIPTION OF DRAWINGS

FIG. 1 is a perspective view of a stretcher 100 provided with a slide mechanism to a rear leg frame;

FIG. 2 is a bottom view of the stretcher 100 provided with the slide mechanism to the rear leg frame;

FIG. 3 s a top view of the stretcher 100 provided with the slide mechanism to the rear leg frame;

FIG. 4 is a side view of the stretcher 100 on which a litter is placed;

FIG. 5 is a side view of the front leg frame folded up forward;

FIG. 6 is a side view of the front leg frame folded up backward;

FIG. 7 is a perspective view of a stretcher 300 provided with a slide mechanism at the lower portion of an upper frame;

FIG. 8 is a side view of the stretcher 300 with leg portions folded backward;

FIG. 9 is a top view of a slide mechanism at the front portion of the stretcher 300;

FIG. 10 is a side view of the stretcher 300 with leg portions folded forward and backward respectively;

FIG. 11 is a top view of a slide mechanism at the rear portion of the stretcher 300; and

FIG. 12 is a top view of the stretcher 300 provided with a slide mechanism under the upper frame.

### BEST MODE FOR CARRYING OUT THE INVENTION

Now, embodiments of the invention will be described with reference to the reference numerals and symbols in the drawings. However, the invention is not limited to the following embodiments. In a stretcher according to the invention, the side thereof closer to an ambulance car when the stretcher is loaded onto the ambulance car will be described as the front portion; and the side thereof farther from the ambulance car will be described as the rear portion. Accordingly, when the stretcher is unloaded from the ambulance car and carried, the stretcher is carried with the rear portion, which has turnable casters, being oriented to the direction of movement.

### Embodiment 1

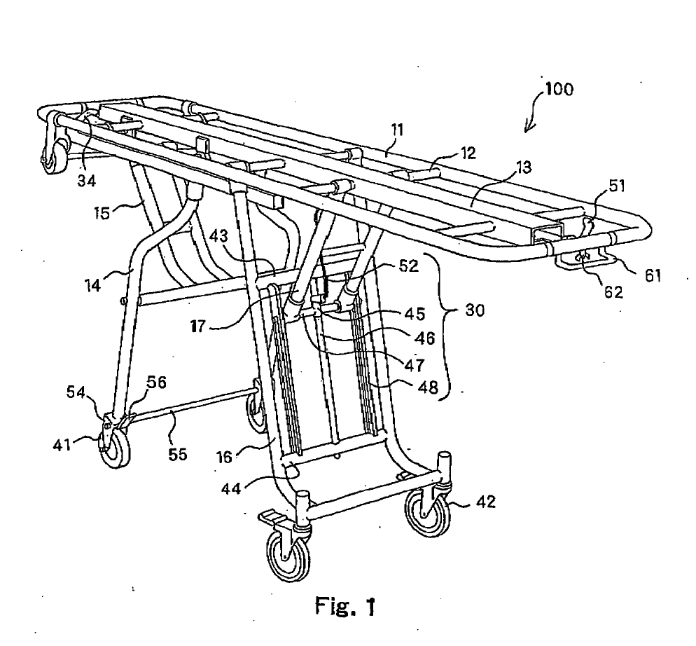

As shown in FIG. 1, a stretcher 100 according to the invention has an upper frame 11. The upper frame 11 has a shape of rectangle frame, and at the inner side thereof, plural inner frames 12, which horizontally bridge the upper frame 11, are provided. A guide cover 13 is provided to the inner frames 12 crossing the same in the front-rear direction. On the upper portion of a front leg frame 14 having un-turnably fixed casters 41 and the front leg auxiliary frame 15, which are under the front portion of the upper frame 11, a front slide mechanism for changing up/down the height of the front side of the upper frame 11 is provided. A rear slide mechanism for changing up/down the height of the rear side of the upper frame 11 is arranged so that a rear leg auxiliary frame 17 slides along a guide rail 46 provided between the right and left rear leg frames 16 having turnable casters 42 respectively, thereby the height of the rear side of the upper frame 11 is changed up and down.

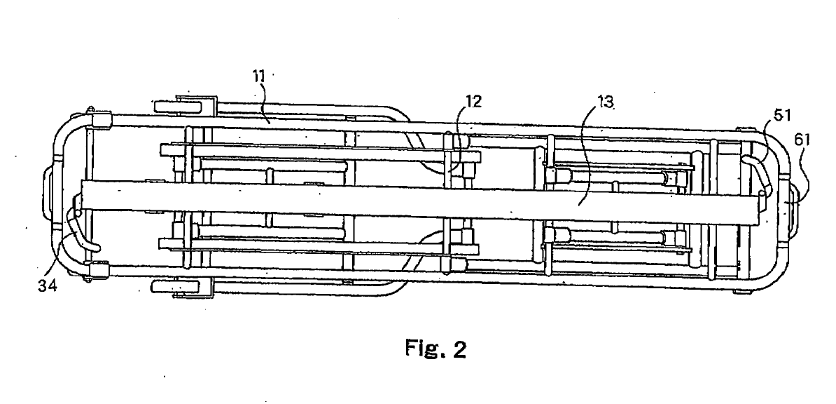

As shown in FIG. 2, on the upper face of the stretcher 100 according to the invention, key-like hooks 61 for fixing a litter are provided at the both ends of the upper frame 11. Provided inside the upper frame 11 are four inner frames, and provided extending thereon is a guide cover 13. At the both ends of the guide cover 13, levers 34 and 51, which are connected to a mechanical lock structure comprising sliding pipes 23, 24 and 45 via wires 33 and 52 respectively, are attached thereto.

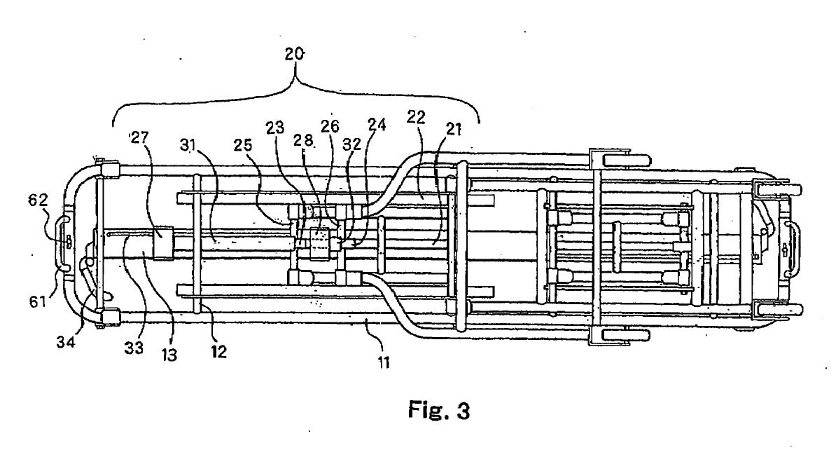

As shown in a bottom view in FIG. 3, a front slide mechanism 20 for changing the height of the front side of the upper frame 11 is provided with a guide rail 21 disposed at the center of the guide cover 13 under the front side thereof. At the right and left sides of the guide rail 21, auxiliary guide rails 22 are disposed, respectively. Sliding pipes 23 and 24 for the front leg auxiliary frame 15 and the front leg frame 14 are engaged with the guide rail 21 being inserted through thereby. The sliding pipes 23 and 24 are provided with support frames 25 and 26 extending in the right and left direction, and the support frames 25 and 26 are movably engaged with the grooves of the auxiliary guide rails 22 respectively. Attached rotatably to the forward support frame 25 is one end of the front leg auxiliary frame 15; and attached rotatably to the central support frame 26 is one end of the front leg frame 14.

Fixedly attached to the front slide mechanism, which changes up/down the front side of the stretcher 100, at two points of a forward portion and a central side portion of the guide cover 13 are constant force springs 27 and 28 for supporting the sliding. A spring 31 extending from the constant force spring 27 is fixedly attached to the sliding pipe 23 of the front leg auxiliary frame 15. The other constant force spring 28 is fixedly attached in a central side portion of the guide cover 13, and a spring 32 extending therefrom is fixedly attached to the sliding pipe 24 of the front leg frame 14.

As for springs to be used here are preferably a spiral spring or the like, which achieves the object without requiring a large space. However, an ordinary coil spring may be used if it supports the up/down movement of the stretcher. When a constant force spring is used, a constant force spring of 10 kg-15 kg or so is preferred. But, the spring may be varied depending on the material, structure or the like of the stretcher 100, and it is not specifically limited to. However, in the case of a light rated load, the constant force spring returns too slowly when sliding up/down the stretcher. On the other hand, in the case of a too heavy rated load, the constant force spring returns too fast when an up/down movement is carried out rendering superfluous uneasiness to a patient. Accordingly, it is desired to use appropriate constant force springs.

The sliding pipes 23 and 24 engaged being inserted with the guide rail 21 include a mechanical lock structure. Ordinary, by tightly holding the guide rail 21, the front leg auxiliary frame 15 and front leg frame 14 are prevented from moving. The sliding pipes 23 and 24 are connected to the lever 34 provided at the front side of the upper frame 11 via the wire 33. When the lever 34 is pulled, the holding is released, and the sliding pipes 23 and 24 of the front leg auxiliary frame 15 and the front leg frame 14 can slide forward and backward on the guide rail 21. To change up/down the height of the stretcher 100, when a front lever 34 provided to the upper frame 11 is pulled, the mechanical lock structures 53 of the sliding pipes 23 and 24 are released. Then, only by gently pressing one end of the upper frame 11 of the stretcher 100, the front side of the stretcher 100 lowers; and when the lever 34 is released at a desired height, the front side of the stretcher 100 is fixed at that position. To raise the stretcher 100, when the lever 34 is pulled, the mechanical lock structures of the sliding pipes 23 and 24 are released. Then, the sliding pipes 23 and 24 of the front leg frame 14 and the front leg auxiliary frame 15 slide on the guide rail 21, and the stretcher 100 can be raised easily owing to the constant force springs 27 and 28. When the lever 34 is released, the stretcher 100 is locked and fixed at a desired height owing to the mechanical lock structures of the sliding pipes 23 and 24.

As for the rear leg frame 16 that has turnable casters 42 on the one ends thereof, as shown in FIG. 1, another ends thereof are rotatably attached to the inner frames 12, which are provided inside the upper frame 11. Between the right and left rear leg frames 16, a rear slide mechanism for changing up/down the height of the upper frame 11 is provided. The rear slide mechanism 30 is provided with the guide rail 46, which is engaged with the sliding pipe 45 being inserted therewith, extending in the vertical direction from an central portion of upper and lower side frames 43 and 44 that are provided between the rear leg frames 16. Securely attached to the sliding pipe 45 inserted through by the guide rail 46 are left and right support frames 47. And the support frames 47 are movably attached to the auxiliary guide rails 48, which are provided at the right and left sides of the guide rail 46, and move up/down. The sliding pipe 45 is connected with the lever 51, which is provided at the rear portion of the upper frame 11, via the wire 52. When the lever 51 is pulled, a mechanical lock structure of the sliding pipe 45 is released. Then, the sliding pipe 45 becomes movable up/down along the guide rail 46 and the height of the rear side of the upper frame 11 can be changed freely.

One ends of the rear leg auxiliary frame 17 are rotatably attached to the inner frames 12, which are provided inside the upper frame 11. The other ends are rotatably attached to the support frames 47, which are provided between the above-described right and left rear leg frames 16. When the lever 51 of the upper frame 11 is pulled, the mechanical lock structure of the sliding pipe 45 is released. When the upper frame 11 is pressed, the sliding pipe 45 attached to the rear auxiliary frame 17 slides on the guide rail 46 causing the rear auxiliary frame 17 slide downward. As a result, the rear leg frame 16 is pressed backward and the rear portion of the stretcher 100 is lowered. To raise the stretcher 100, when the rear lever 51 is pulled, the mechanical lock structure of the sliding pipe 45 is released. By being lifted up gently, the stretcher 100 is returned upward. When the lever 51 is released, the mechanical lock structure is locked and the stretcher 100 is fixed at a desired height.

The auxiliary guide rails 48 provides such effects that, in addition to allowing the rear leg auxiliary frame 17 to slide smoothly, the load applied to the guide rail 46 from the top is dispersed and born by the rear leg auxiliary frame 17. According to this embodiment, as for the auxiliary guide rails 48, square members are formed with a groove respectively to allow the support frames 47 to move freely. However, for example, it may be arranged so that the support frames 47 can move freely within a pipe. The method is not limited to the method of this embodiment. Any method, in which the rear leg auxiliary frame 17 moves smoothly and the strength is provided to bear the force applied to the guide rail 46 by the rear leg auxiliary frame 17, may be adopted.

As for the method to rotatably attach the rear leg frame 16 and the rear leg auxiliary frame 17 to the inside of the upper frame 11, the same may be attached rotatably to the inner frames 12, which are horizontally bridged to the upper frame 11. Or, it may be arranged so that the upper frame 11 is provided with side plates, and the side plates is fixedly attached with pipes having a diameter slightly smaller than that of the rear leg frame 16 and the rear leg auxiliary frame 17 to allow the rear leg frame 16 and the rear leg auxiliary frame 17 to be engaged freely rotatably. Or, it may be arranged so that bearings are attached to the appropriate positions in the upper frame 11, and that the rear leg frame 16 and the rear leg auxiliary frame 17 are attached thereto. Any method, in which the rear leg frame 16 and the rear leg auxiliary frame 17 rotate smoothly, may be adopted.

As shown in FIG. 1, disposed in a front portion of the upper frame 11 are auxiliary casters 53 for loading the stretcher smoothly onto an ambulance car. Further, the casters 41 provided to the front leg frame 14 are the un-turnable fixed casters. And it is arranged so that the right and left stoppers 54 of the casters 41 are interlocked by a pipe 55 so as to lock the other stopper 54 as well by stepping on either one of the stopper pedals 56. As a result, when either one of right and left stopper pedals 56 of the front fixed casters are stepped on, both of the front casters 41 are fixed at the same time. The method to activate the stoppers 54 synchronously is not limited to the method in which the right and left stoppers 54 are interlocked by the pipe 55. For example, a wire may be used. Any method, in which the right and left casters 41 are fixed at the same time, may be adopted.

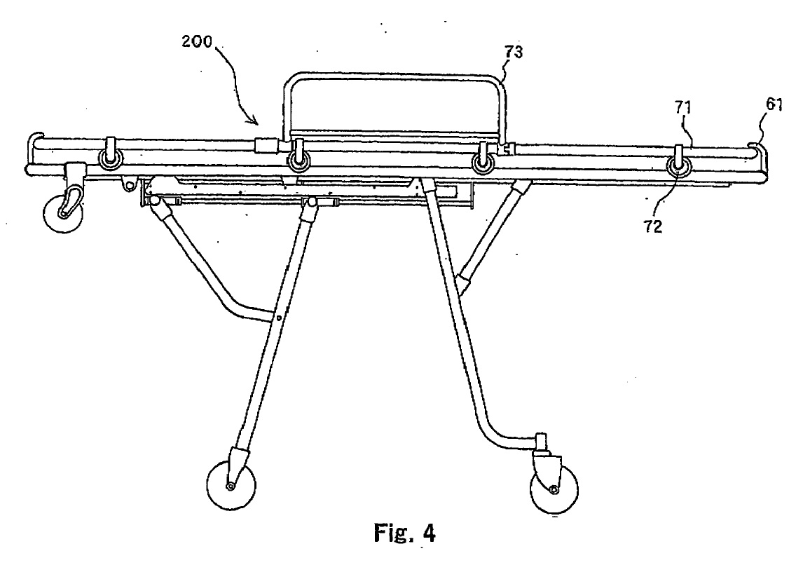

Disposed at the both ends in the longitudinal direction of the upper frame 11 are key hooks 61 for fixing a litter 200. Ordinarily, the key hooks 61 are disposed being oriented downward. When the litter 200 is placed and fixed, as shown in FIG. 4, the key hooks 61 are turned upward to engage with an upper frame 71 of the litter 200 at the both ends thereof and are fixed with pins 62 (FIG. 1).

When the key-like hook 61 engages with the upper frame 71 of the litter 200, the pin 62 is brought into engagement with a hole, which is previously formed in the upper frame 11, by the spring function to fix the key-like hook 62. To release the key-like hook 61, the head of the pin 62 is pulled up. Then, the spring is contracted and the pin 62 can be pulled out easily from the hole. As a result, the engagement of the key-like hook 61 is released.

The method of fixing the litter 200 to the upper portion of the stretcher 100 is not limited to the key-like hooks 61, which is formed with a pipe, according to the embodiment 1. A key-like hook, which is formed into a plate-like shape or the like, may be used. Further, not to the both ends in the longitudinal direction, but to appropriate positions on the both sides in crosswise direction, one or several hooks may be provided. Or a groove for engaging with the litter 200 may be formed on the stretcher 100. Generally, the case that the stretcher 100 is required is an emergent case. Therefore, any method, which is capable of fixing the litter 200 placed on the stretcher 100 quickly and securely, may be adopted. As for the fixing method of the key-like hooks, in addition to the above-described method in which a pin is brought into engagement with a previously formed hole, a method of fixing the key-like hook is exemplified in which a means for screwing to fix is attached to the lower portion of the key-like hook. The fixing method is not limited to the above method but any method, which is capable of fixing and releasing the key-like hook easily and securely, may be adopted.

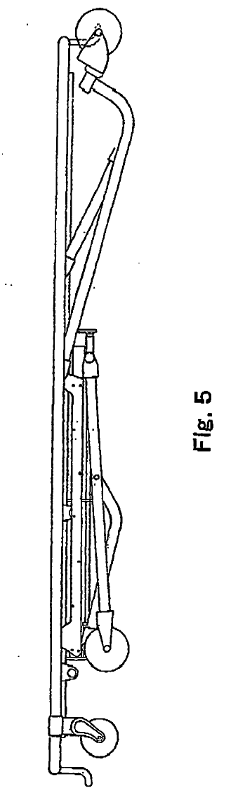

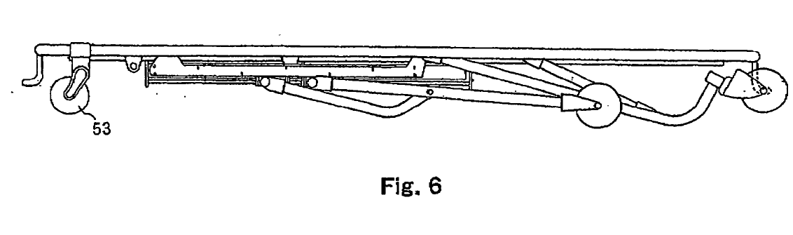

When a patient is transferred to a bed or the like, in order to adjust to the height of the bed, the front and rear levers 34 and 51 of the stretcher 100 are pulled and the upper frame 11 is pressed slightly at the front and rear portions to adjust the height of the stretcher to the height of the bed. Then, by releasing the levers 34 and 51, the stretcher 100 is fixed at that position. To fold the leg portions, the front and rear levers 34 and 51 provided to the upper frame 11 are pulled, and the upper frame 11 is pressed gently at the front and rear portions from the top. Then, as shown in FIG. 5, the leg portions can be folded easily. Further, when the stretcher is transferred to an ambulance car or the like, after placing the front auxiliary casters 53 on the rear portion of the ambulance car, the stretcher 100 is pushed. Then, the front leg frame 15 is pushed backward and, as shown in FIG. 6, the front leg frame 15 is folded backward. Thus, the stretcher is easily transferred to the ambulance car.

Since the constant force spring and the mechanical lock structure are used in the front and rear slide mechanisms of the stretcher, it is made possible to slide the stretcher up/down in a non-step manner and the stretcher can be fixed at any height. The stretcher slides up/down smoothly without generating vibration and the stretcher is prevented from lowering suddenly due to a malfunction. Thus, a stretcher, which does not render superfluous uneasiness or sensation of fear to a sick person or injured person, is provided. Furthermore, since un-turnable fixed casters are used for the front casters, the stretcher can be steered stably. Still further, since the right and left stoppers of the front fixed casters are interlocked to each other, the right and left casters can be fixed at the same time by stepping on one stopper. Since key-like hooks for fixing the stretcher are provided, the litter can be fixed to the stretcher easily. And since the fixing key-like hooks are provided externally, it can be easily checked whether the litter is fixed.

### Embodiment 2

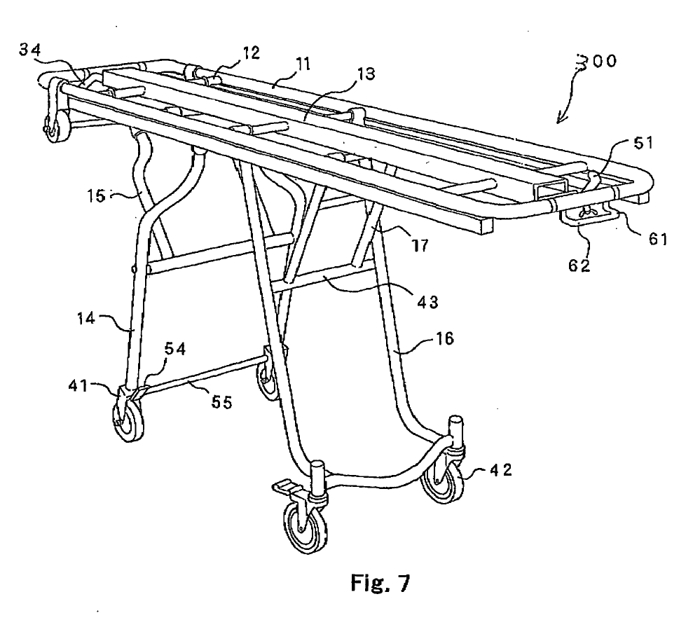

As shown in FIG. 7, a stretcher 300 according to the invention has an upper frame 11. The upper frame 11 has a shape of rectangle frame, and at the inner side thereof, plural inner frames 12, which horizontally bridge the upper frame 11, are provided. A guide cover 13 is provided to the inner frames 12 crossing the same in the front-rear direction. On the upper portion of front leg frame 14 having un-turnable fixed casters 41 and the front leg auxiliary frame 15, which are under the front portion of the upper frame 11, a front slide mechanism 20 for changing up/down the height of the front side of the upper frame 11 is provided. A rear slide mechanism 30 for changing up/down the height of the rear side of the upper frame 11 is disposed on parallel with the front slide mechanism 20 under the upper frame 11 and on the rear leg auxiliary frame 17.

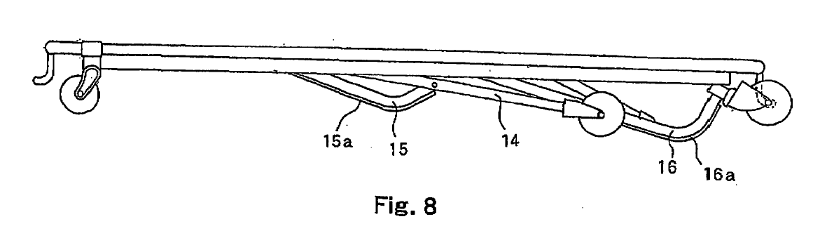

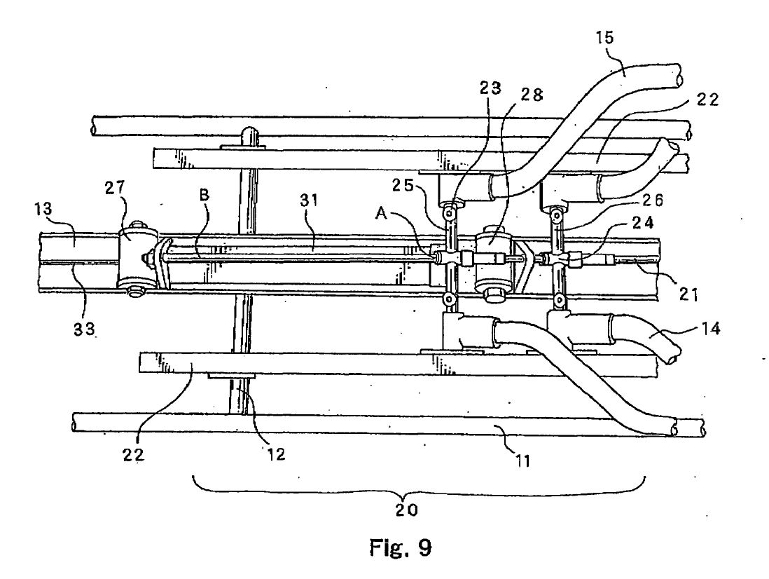

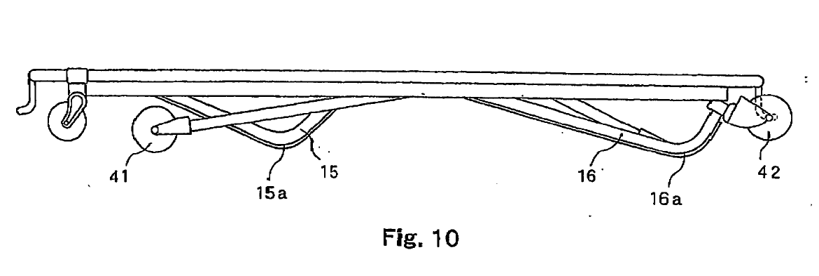

FIG. 8 shows the folding mode of the stretcher 300 when the stretcher 300 is loaded on an ambulance car. When the front leg frame 14 with the fixed casters 41 is pushed into an ambulance car or the like, the front leg frame 14 is pressed backward by the rear-loading platform of the ambulance car. Thus, the front leg frame 14 of the stretcher 300 is folded backward, and the fixed casters 41 and the turnable rear leg casters 42 are folded backward as well. As for the front slide mechanism 20 in the above case, as shown in FIG. 9, the mechanical lock structure of the front leg auxiliary frame 15 is sandwiched along with the mechanical lock structure of the front leg frame 14 at the position-A in a central side area. When the stretcher 300 is pressed down with the levers 34 and 51 being pulled, as shown in FIG. 10, the front and rear casters 41 and 42 are disposed at the front and rear portions of the stretcher 300 respectively and folded therein. In this case, the mechanical lock structure of the front leg auxiliary frame 15 is sandwiched at the position-B shown in FIG. 9.

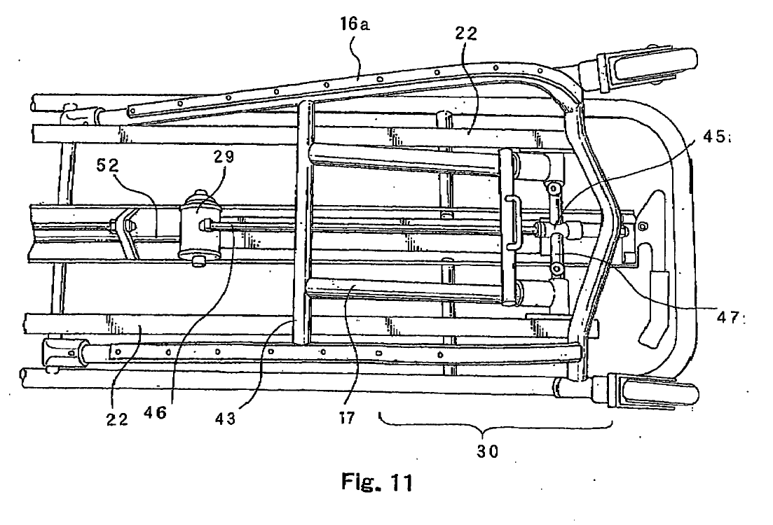

As shown in FIG. 11, the rear slide mechanism 30 of the rear leg auxiliary frame 17 is disposed in a rear lower portion of the upper frame 11. It is arranged so that, when the rear leg frame 16 is folded, the mechanical lock structure fixedly attached to the rear leg auxiliary frame 17 in a slidable manner is pushed backward to allow the rear leg frame 16 to be folded.

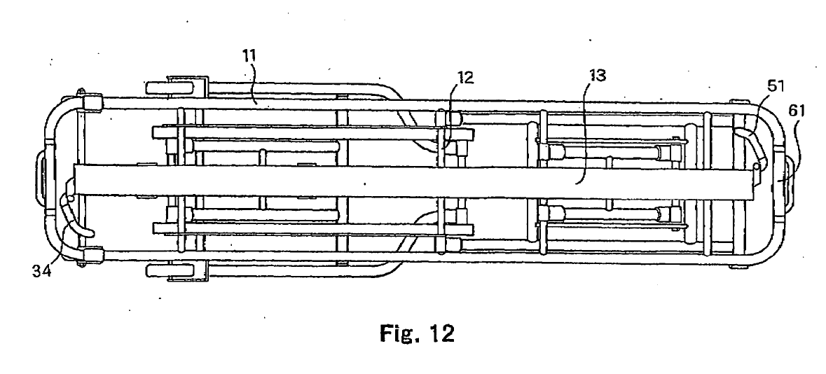

Further detailed description will be made below. As shown in FIG. 12, on the upper face of the stretcher 300 according to the invention, key-like hooks 61 for fixing a litter are provided at the both ends of the upper frame 11. Provided inside the upper frame 11 are four inner frames, and provided extending thereon is a guide cover 13. At the both ends of the guide cover 13, levers 34 and 51, which are connected to a mechanical lock structure comprising sliding pipes 23, 24 and 45 via wires 33 and 52 respectively, are attached thereto.

As shown in a bottom view in FIG. 9, a front slide mechanism 20 for changing the height of the front side of the upper frame 11 is provided with guide rails 21 and 31 disposed at the center of the guide cover 13 under the front side thereof. Also, at the right and left sides of the guide rails 21 and 31, auxiliary guide rails 22 are disposed, respectively. Sliding pipes 23 and 24 for the front leg auxiliary frame 15 and the front leg frame 14 are engaged with the guide rails 21 and 31 being inserted through thereby. The sliding pipes 23 and 24 are provided with support frames 25 and 26 extending in the right and left direction, and the support frames 25 and 26 are movably engaged with the grooves of the auxiliary guide rails 22 respectively. One end of the front leg auxiliary frame 15 is attached rotatably to the forward support frame 25; and one end of the front leg frame 14 is attached rotatably to the central support frame 26.

To the front slide mechanism 20, which changes up/down the front side of the stretcher 300, constant force springs 27 and 28 for supporting the sliding are fixedly attached at two points of a forward portion and a central side portion of the guide cover 13. A spring 31 extending from the constant force spring 27 is fixedly attached to the sliding pipe 23 of the front leg auxiliary frame 15. The other constant force spring 28 is fixedly attached in the central side portion of the guide cover 13, and a spring 32 extending therefrom is fixedly attached to the sliding pipe 24 of the front leg frame 14.

Here, as for the spring to be used is preferably a spiral spring or the like, which achieves the object without requiring a large space. But, an ordinary coil spring, which supports the up/down movement of the stretcher, may also be used. When a constant force spring is used, a constant force spring of 5 kg-15 kg or so is preferred. However, the spring may be varied depending on the material, structure or the like of the stretcher 300, and it is not specifically limited to. However, in the case of a light rated load, the constant force spring returns too slowly when sliding up/down the stretcher. On the other hand, in the case of a too heavy rated load, the constant force spring returns too fast when an up/down movement is carried out rendering superfluous uneasiness to a patient. Accordingly, it is desired to use appropriate constant force springs.

The sliding pipes 23 and 24, which are engaged with the guide rails 21 and 46 being inserted thereby respectively, include mechanical lock structures. Ordinary, by tightly holding the guide rails 21 and 46, the sliding pipes 23 and 24 prevent the front leg auxiliary frame 15 and front leg frame 14 from moving. The sliding pipes 23 and 24 are connected to the lever 34 provided at the front side of the upper frame 11 via the wire 33. When the lever 34 is pulled, the holding is released, and the sliding pipes 23 and 24 of the front leg auxiliary frame 15 and the front leg frame 14 can slide forward and backward on the guide rail 21. To change up/down the height of the stretcher 300, when a front lever 34 provided to the upper frame 11 is pulled, the mechanical lock structures of the sliding pipes 23 and 24 are released. Then, only by gently pressing one end of the upper frame 11 of the stretcher 300, the front side of the stretcher 300 lowers; and when the lever 34 is released at a desired height, the front side of the stretcher 300 is fixed at that position. To raise the stretcher 300, the mechanical lock structures of the sliding pipes 23 and 24 are released when the lever 34 is pulled. Then, the sliding pipes 23 and 24 of the front leg frame 14 and the front leg auxiliary frame 15 slide on the guide rails 21 and 31 owing to the constant force springs 27 and 28, and the stretcher 300 can be raised easily. When the lever 34 is released, the stretcher 300 is locked and fixed at a desired height owing to the mechanical lock structures of the sliding pipes 23 and 24.

As for the rear leg frame 16 that has turnable rear casters 42 on the one ends thereof, as shown in FIG. 11, another ends thereof are rotatably attached to the inner frames 12, which are provided inside the upper frame 11. On the right and left rear leg frames 16 and under the upper frame 11, a rear slide mechanism 30 for changing up/down the height of the rear side of the upper frame 11 is provided. The rear slide mechanism 30 is provided with the guide rail 46, which is engaged with the sliding pipe 45 being inserted with the rear leg frame 16, under the upper frame 11. Left and right support frames 47 are securely attached to the sliding pipe 45 inserted through by the guide rail 46. And the support frames 47 are movably attached to the auxiliary guide rails 22, which are provided at the right and left sides of the guide rail 46, and move forward/backward. The sliding pipe 45 is connected with the lever 51, which is provided at the rear portion of the upper frame 11, via the wire 52. When the lever 51 is pulled, a mechanical lock structure of the sliding pipe 45 is released. Then, the sliding pipe 45 becomes movable forward/backward along the guide rail 46 and the height of the rear side of the upper frame 11 can be changed freely.

When the lever 51 of the upper frame 11 is pulled, the mechanical lock structure of the sliding pipe 45 is released. Then, when the upper frame 11 is pressed, the sliding pipe 45 attached to the rear auxiliary frame 17 slides on the guide rail 46 causing the rear auxiliary frame 17 slide backward. As a result, the rear leg frame 16 is pressed backward and the rear portion of the stretcher 300 is lowered. To raise the stretcher 300, when the rear lever 51 is pulled, the mechanical lock structure of the sliding pipe 45 is released. By being lifted up gently, the stretcher 300 is returned upward and the rear leg is raised. When the lever 51 is released, the mechanical lock structure is locked. As a result, the stretcher 300 is fixed at a desired height.

Elastic rubber members 15a and 16a may be attached to the surfaces of the rear leg frame 16 and the front leg auxiliary frame 15 where come into contact with the ground, i.e., the surfaces of the rear leg frame 16 and the front leg auxiliary frame 15 as shown in FIG. 8, FIG. 10 and FIG. 11, where come into contact with the ground when the stretcher is folded. Owing to this arrangement, the portions of the rear leg frame 15 and the front leg auxiliary frame 16, where come into contact with the ground, are protected. Further such effect that the shock to a patient is reduced, and the loading platform of the ambulance car is protected as well. The rubber-members 15a and 16a attached to these portions are not limited to rubber. Any synthetic rubbers, synthetic resin plates or the like, which have a durability and elasticity, may be used. Further, in order to facilitate the stretcher to slide when the stretcher is loaded onto the loading platform of the ambulance car, a synthetic resin plate may be further attached on the rubber-members 15a and 16a. As described above, by attaching elastic rubber-members to the surfaces of the rear leg frame and the front leg auxiliary frame where come into contact with the ground, not only the portions of the rear leg frame and the front leg auxiliary frame, where come into contact with the ground are protected, but also such effect that the shock to a patient is reduced and the loading platform of the ambulance car is protected or the like is obtained.

### Industrial Applicability

As described above, the stretcher according to the invention can, even when loading onto an ambulance car, be easily loaded thereon only by pushing the same with the lever being griped. Further, even when the stretcher is moved up/down with a patient thereon, a patient is given with little uneasiness or pain since little vibration is generated. Thus, the stretcher is suitable for loading onto an ambulance car.

What is claimed is:

1. A stretcher comprising an upper frame for placing a litter on an upper portion thereof having a caster in the front portion and rear portion, and a slide mechanism for changing up/down the position of said upper frame, wherein:
a non-step stopper mechanism for stopping the sliding in said slide mechanism in a non-step manner,
a front leg slide mechanism is provided in a lower portion of the upper frame, and a rear leg frame slide mechanism is provided to a rear leg.

2. The stretcher according to claim 1, wherein the sliding of the slide mechanism is made by the expansion and contraction of a constant force spring.

3. The stretcher according to claim 1, wherein the non-step stopper mechanism comprises a mechanical lock structure.

4. The stretcher according to claim 1, wherein the front caster is an un-turnable fixed caster.

5. The stretcher according to claim 1, wherein a stopper is disposed to the right and left front fixed casters respectively, and said right and left stoppers are interlocked with each other.

6. The stretcher according to claim 1, wherein the litter can be fixed by a key-like hook on the upper frame.

7. A stretcher comprising an upper frame for placing a litter on an upper portion thereof having a caster in the front portion and rear portion, and a slide mechanism for changing up/down the position of said upper frame, wherein:
a non-step stopper mechanism for stopping the sliding in said slide mechanism in a non-step manner,
a front leg slide mechanism and a rear leg slide mechanism are provided in a lower portion of the upper frame.

8. The stretcher according to claim 7, wherein sliding of the slide mechanism is made by the expansion and contraction of a constant force spring.

9. The stretcher according to claim 7, wherein the non-step stopper mechanism comprises a mechanical lock structure.

10. The stretcher according to claim 7, wherein the front caster is an un-turnable fixed caster.

11. The stretcher according to claim 7, wherein a stopper is disposed to the right and left front fixed casters respectively, and the right and left stoppers are interlocked with each other.

12. The stretcher according to claim 7, wherein the litter can be fixed by a key-like hook on the upper frame.
